(19) United States
(12) Patent Application Publication
(10) Pub. No.: US 2026/0115656 A1
(43) Pub. Date: Apr. 30, 2026

(54) ELECTROCHEMICAL CELL

(71) Applicant: DENSO CORPORATION, Kariya-city (JP)

(72) Inventors: Nobuhiko MATSUDA, Kariya-city (JP); Atsuhito Ota, Nisshin-sity (JP); Naohisa Oyama, Nisshin-city (JP); Shota Kinoshita, Nisshin-city (JP); Hironori Tatsumi, Kariya-city (JP)

(21) Appl. No.: 19/009,082

(22) Filed: Jan. 3, 2025

Related U.S. Application Data
(63) Continuation of application No. PCT/JP2023/023892, filed on Jun. 28, 2023.

(30) Foreign Application Priority Data
Jul. 6, 2022 (JP) 2022-109069

(51) Int. Cl. B01D 53/32

(52) U.S. Cl. CPC B01D 53/326

(57) ABSTRACT

An electrochemical cell has a working electrode and a counter electrode. The electrochemical cell adsorbs a gas to the working electrode and desorbs the adsorbed gas from the working electrode, by applying a voltage between the working electrode and the counter electrode. At least one electrode of the working electrode and the counter electrode has conductive particles that contact each other to form conductive paths and functional particles that do not form the conductive paths. A particle diameter of the conductive particles is configured to be greater than or equal to a particle diameter of the functional particles.

### CROSS-REFERENCE TO RELATED APPLICATION

The present application is a continuation application of International Application No. PCT/JP2023/023892, filed on Jun. 28, 2023, which claims priority to Japanese Patent Application No. 2022-109069, filed in Japan on Jul. 6, 2022. The contents of these applications are incorporated herein by reference in their entirety.

### BACKGROUND

### 1. Technical Field

The present disclosure relates to an electrochemical cell that adsorbs gases.

### 2. Related Art

An electrochemical cell captures a specific gas from a gas mixture by adsorbing it through an electrochemical reaction.

### SUMMARY

The present disclosure provides an electrochemical cell. As an aspect of the present disclosure, an electrochemical cell of the present disclosure has a working electrode and a counter electrode. The electrochemical cell adsorbs a gas to the working electrode and desorbs the adsorbed gas from the working electrode by applying a voltage between the working electrode and the counter electrode. At least one electrode of the working electrode and the counter electrode has conductive particles that contact each other to form conductive paths and functional particles that do not form the conductive paths. A particle diameter of the conductive particles is configured to be greater than or equal to a particle diameter of the functional particles.

### BRIEF DESCRIPTION OF THE DRAWINGS

In the accompanying drawings:

FIG. 1 is a conceptual diagram illustrating an overall configuration of a carbon dioxide capture system in a first embodiment;

FIG. 2 is an explanation diagram illustrating a configuration of the carbon dioxide capture system;

FIG. 3 is an explanation diagram illustrating a configuration of an electrochemical cell in the carbon dioxide capture system;

FIG. 4 is a diagram illustrating a configuration of a working electrode of the electrochemical cell;

FIG. 5 is an enlarged view illustrating materials made of the working electrode;

FIG. 6 is a diagram showing a relationship between electrical conductivity of an electrode containing conductive particles and a volume ratio of the conductive particles in the electrode;

FIG. 7 is a diagram showing a relationship between a particle diameter and an abundance ratio of particles when the particle diameter is adjusted; and

FIG. 8 is an enlarged view illustrating materials made of a working electrode in a second embodiment.

### DETAILED DESCRIPTION OF THE PREFERRED EMBODIMENTS

JP-T-2018-533470 A (Japanese Translation of PCT International Application Publication No. JP-T-2018-533470) discloses an electrochemical cell that captures a specific gas to be captured from a gas mixture. The electrochemical cell described in JP-T-2018-533470 A has a pair of electrodes containing a working electrode and a counter electrode and adsorbs the specific gas by an electrochemical reaction. The working electrode contains a gas adsorbent that adsorbs the specific gas from the gas mixture and a conductive auxiliary agent that forms a conductive path to the gas adsorbent. The counter electrode contains an electroactive auxiliary material that transfers electrons to and from the working electrode and a conductive auxiliary agent that forms a conductive path to the electroactive auxiliary material.

For example, when conductive particles are used as the conductive auxiliary agent and functional particles are used as the gas adsorbent and the electroactive auxiliary material, it is necessary to ensure electrical conductivity provided by the conductive particles and improve functionality provided by the functional particles to increase the gas adsorption efficiency of an electrochemical cell.

Given the above points, the present disclosure aims to both ensure electrical conductivity by conductive particles and improve functionality by functional particles in an electrochemical cell for gas adsorption with the conductive particles and the functional particles.

In order to achieve the above objective, an electrochemical cell of the present disclosure has a working electrode and a counter electrode. The electrochemical cell of the present disclosure adsorbs a gas to the working electrode and desorbs the adsorbed gas from the working electrode by applying a voltage between the working electrode and the counter electrode. At least one electrode of the working electrode and the counter electrode has conductive particles that contact each other to form conductive paths and functional particles that do not form the conductive paths. A particle diameter of the conductive particles is configured to be greater than or equal to a particle diameter of the functional particles.

This allows the electrochemical cell of the present disclosure to increase a contact ratio between the conductive particles in the electrode, thereby improving the electrical conductivity of the electrode. Therefore, the electrochemical cell of the present disclosure can ensure the electrical conductivity provided by the conductive particles even when a volume ratio of the conductive particles is reduced. Furthermore, the electrochemical cell of the present disclosure can improve the functionality provided by the functional particles due to increasing a volume ratio of the functional particles.

The following is a description of several embodiments for implementing the present disclosure with reference to the drawings. In each embodiment, the items described in previous embodiments share the same reference number, and duplicate explanations may be omitted. In each embodiment, a part of a configuration may be described. Note that a description of the previous embodiments can be applied to other configuration parts. In each embodiment, it may be explicitly stated that each configuration can be combined. Each configuration can be combined even if not explicitly stated in each embodiment, as long as there are no obstacles to combining them.

### First Embodiment

A first embodiment of an electrochemical cell of the present disclosure will be described below. In the present embodiment, the electrochemical cell of the present disclosure is applied to a carbon dioxide capture system 1 that separates carbon dioxide from a gas mixture containing carbon dioxide, thus capturing the separated carbon dioxide. Therefore, the captured gas in the present embodiment is carbon dioxide.

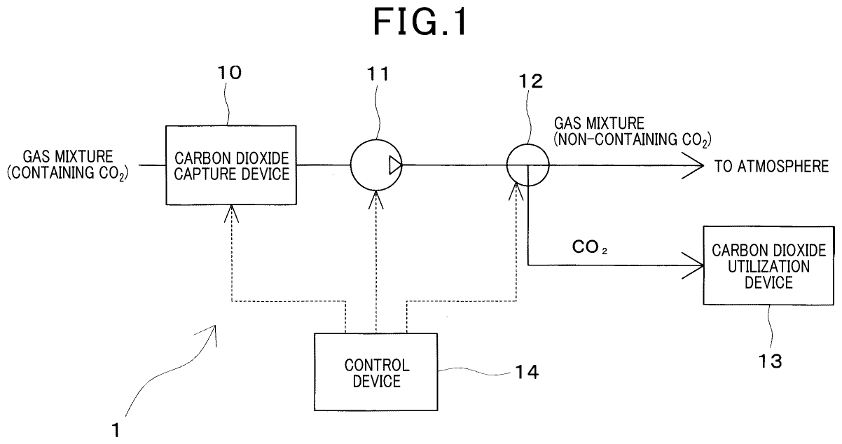

As shown in FIG. 1, the carbon dioxide capture system 1 includes a carbon dioxide capture device 10, a pump 11, a flow-path switching valve 12, a carbon dioxide utilization device 13, and a control device 14.

The carbon dioxide capture device 10 separates carbon dioxide from the gas mixture and capture the separated carbon dioxide. For example, an atmosphere or an exhaust gas from an internal combustion engine may be used as the gas mixture. The gas mixture contains oxygen and other gases in addition to carbon dioxide. The gas mixture is supplied to the carbon dioxide capture device 10. The carbon dioxide capture device 10 discharges the gas mixture after the carbon dioxide has been separated, or the captured carbon dioxide. The detailed configuration of the carbon dioxide capture device 10 will be described below.

An inlet of the pump 11 is connected to an outlet of the carbon dioxide capture device 10. The pump 11 suctions the gas mixture after the carbon dioxide has been separated or the captured carbon dioxide, from the carbon dioxide capture device 10. Furthermore, the gas mixture is supplied to the carbon dioxide capture device 10 by a suction action of the pump 11.

The present embodiment describes the pump 11 disposed downstream of the carbon dioxide capture device 10 in a gas flow direction. The pump 11 may be disposed upstream of the carbon dioxide capture device 10 in the gas flow direction.

An inlet of the flow-path switching valve 12 is connected to the outlet of pump 11. The flow-path switching valve 12 is a three-way valve that switches a gas flow path of the gas flowing out of the carbon dioxide capture device 10. The flow-path switching valve 12 switches a gas flow path to direct the gas flowing out from the carbon dioxide capture device 10 to the atmosphere and a gas flow path to direct the gas flowing out from the carbon dioxide capture device 10 to the carbon dioxide utilization device 13.

The carbon dioxide utilization device 13 is a device that uses the carbon dioxide. The carbon dioxide utilization device 13 may be, for example, a storage tank that stores the carbon dioxide, a converter that converts the carbon dioxide into a fuel, or the like. The converter is a device that converts the carbon dioxide into methane or other hydrocarbon fuels. The hydrocarbon fuels may be gaseous fuels under a normal temperature and a normal pressure, or liquid fuels under the same conditions.

The control device 14 includes a microcomputer and peripheral circuits, and the microcomputer includes a CPU, ROM, RAM, and the like. The control device 14 performs various calculations and various control processes based on a control program stored in the ROM, and controls operations of various control target devices connected as output destinations. Specifically, the control device 14 controls the operations of the carbon dioxide capture device 10, the pump 11, and the flow-path switching valve 12.

The carbon dioxide capture device 10 will be described below.

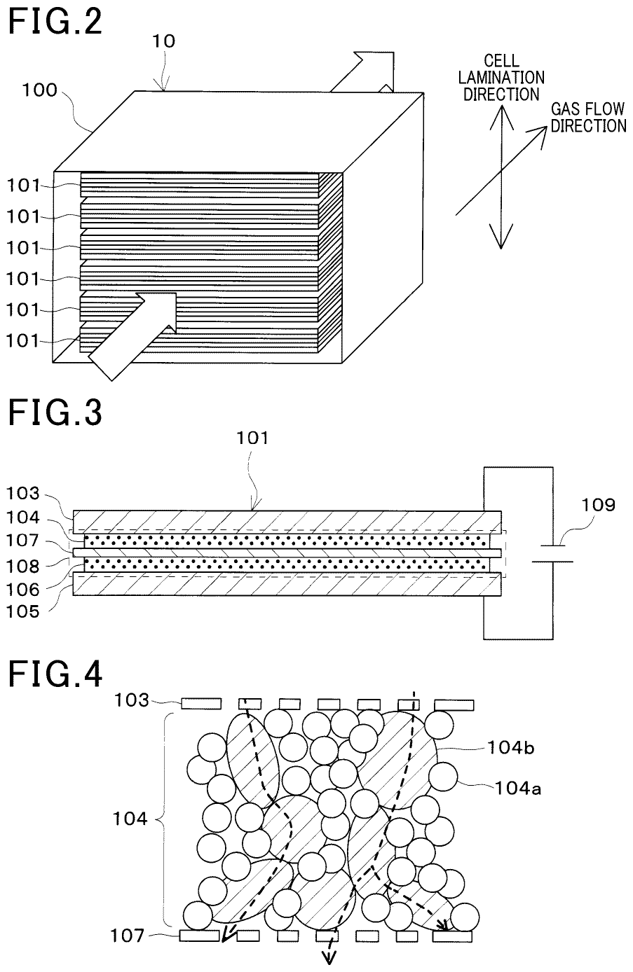

As shown in FIG. 2, the carbon dioxide capture device 10 includes a housing 100 and a plurality of electrochemical cells 101. The housing 100 of the present embodiment is formed by metallic material. The housing 100 may be formed by resin material.

The housing 100 has a gas inlet and a gas outlet. The gas inlet is an opening that allows the gas mixture to flow into the housing 100. The gas outlet is an opening that allows the gas mixture after the carbon dioxide has been separated or the captured carbon dioxide, to flow out from the housing 100.

The electrochemical cell 101 separates the carbon dioxide from the gas mixture by adsorbing the carbon dioxide to the cell through an electrochemical reaction and captures the separated carbon dioxide. The electrochemical cell 101 desorbs carbon dioxide from the cell through the electrochemical reaction and releases the carbon dioxide adsorbed to the cell to an outside. The plurality of electrochemical cells 101 is housed in the housing 100.

The electrochemical cell 101 is formed as a rectangular flat plate. The plurality of electrochemical cells 101 is stacked and arranged in the housing 100 at regular intervals so that their plate faces are parallel to each other. A plurality of gas flow paths is formed between adjacent electrochemical cells 101 to flow the gas mixture that flows from the gas inlet.

As shown in FIG. 3, the electrochemical cell 101 includes a working electrode current collector 103, a working electrode 104, a counter electrode current collector 105, a counter electrode 106, a separator 107, and an electrolyte layer 108. The working electrode current collector 103, the working electrode 104, the counter electrode current collector 105, the counter electrode 106, and the separator 107 are all formed as rectangular flat plates. The working electrode 104 and the counter electrode 106 constitute a pair of electrodes.

The electrochemical cell 101 is formed as a laminate, layering the working electrode current collector 103, the working electrode 104, the counter electrode current collector 105, the counter electrode 106, and the separator 107. A lamination direction in which the working electrode current collector 103 and other elements are laminated in each electrochemical cell 101 coincides with a lamination direction in which the plurality of electrochemical cells 101 is stacked inside the housing 100.

The working electrode current collector 103 is a conductive member that contacts the working electrode 104 and electrically connects the working electrode 104 to the counter electrode 106. One flat surface of the working electrode current collector 103 is exposed and in contact with the gas mixture. The other flat surface of the working electrode current collector 103 is in contact with the working electrode 104.

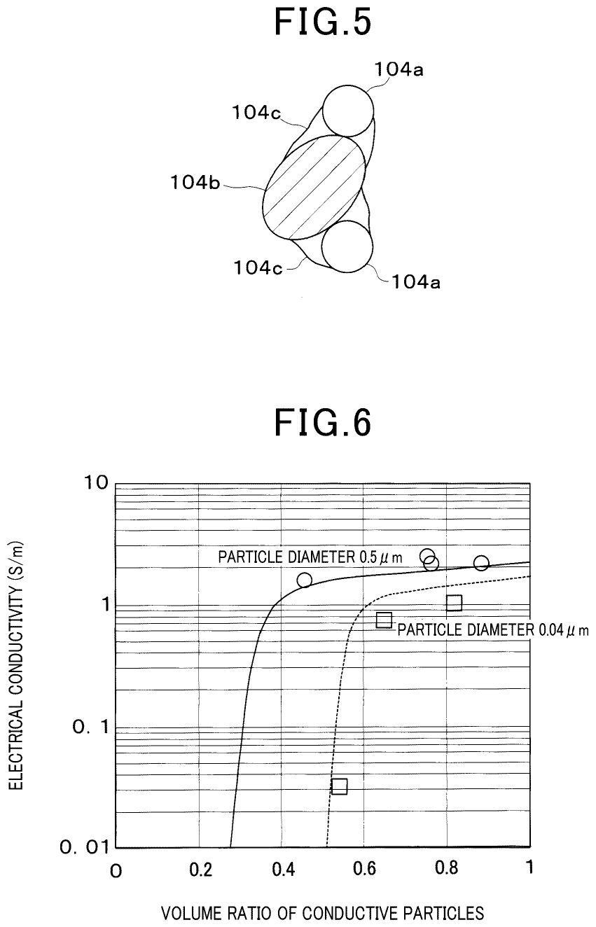

As shown in FIG. 4, the working electrode 104 is provided between the working electrode current collector 103 and the separator 107. As shown in FIGS. 4 and 5, the working electrode 104 includes a carbon dioxide adsorbent 104a, a conductive auxiliary agent 104b, and a binder 104c. In FIGS. 4 and 5, the conductive auxiliary agent 104b is shown by shaded lines. In FIG. 4, the binder 104c is not shown. The carbon dioxide adsorbent 104a, the conductive auxiliary agent 104b, and the binder 104c are not limited to shapes and sizes illustrated in FIGS. 4 and 5.

The carbon dioxide adsorbent 104a, the conductive auxiliary agent 104b, and the binder 104c are used in a mixed state (mixture). Specifically, in the present embodiment, particles of the carbon dioxide adsorbent 104a and particles of the conductive auxiliary agent 104b are held together by the binder 104c. The working electrode 104 can adsorb the carbon dioxide from the gas mixture to the electrode and capture the carbon dioxide. The working electrode 104 can desorb the captured carbon dioxide from the electrode and release the captured carbon dioxide.

The carbon dioxide adsorbent 104a is an electroactive species that adsorbs the carbon dioxide by receiving an electron and desorbs the adsorbed carbon dioxide by releasing an electron. The carbon dioxide adsorbent 104a is an example of a gas adsorbent. For example, polyanthraquinone, a carbon material, metal oxide, or the like, may be used as the carbon dioxide adsorbent 104a. In the present embodiment, the polyanthraquinone is used as the carbon dioxide adsorbent 104a.

The conductive auxiliary agent 104b is a conductive material that forms a conductive path to the carbon dioxide adsorbent 104a. For example, the carbon material, a porous metal material, a metal-supported ceramic, or the like, may be used as the conductive auxiliary agent 104b. The carbon material configuring the conductive auxiliary agent 104b may be used carbon black, a carbon nanotube, graphene, a carbon fiber nonwoven fabric, or the like.

The binder 104c is a polymeric binder that holds the carbon dioxide adsorbent 104a and the conductive auxiliary agent 104b. The binder 104c binds the carbon dioxide adsorbent 104a to each other. The binder 104c binds the conductive auxiliary agent 104b to each other. The binder 104c binds the carbon dioxide adsorbent 104a with the conductive auxiliary agent 104b. For example, a fluoropolymer such as polytetrafluoroethylene (PTFE) and polyvinylidene fluoride (PVDF) may be used as the binder 104c. In the present embodiment, a non-conductive polymer without electrical conductivity is used as the binder 104c.

The working electrode 104 includes conductive particles whose main purpose is to exhibit the electrical conductivity and functional particles whose main purpose is to exhibit functions other than the electrical conductivity. In the present embodiment, the conductive particles contain the conductive auxiliary agent 104b and the functional particles contain the carbon dioxide adsorbent 104a.

The conductive particles contact each other to form the conductive path, which is a path for electrons to pass through. The conductive particles are in continuous contact with other adjacent conductive particles and configure a conductive framework of the working electrode 104. The conductive framework is a continuous structure of the conductive particles forming the conductive path. The dashed lines in FIG. 4 show the conductive paths. In the working electrode 104, the conductive path with the conductive auxiliary agent 104b is formed in a three-dimensional shape.

The functional particles are basically non-conductive substances or substances that are less conductive than the conductive particles. Adjacent functional particles are not in continuous contact with each other, and the functional particles do not form the conductive path.

The conductive particles and the functional particles are particulate matter. The conductive particles and the functional particles are irregularly shaped and include spherical, lumpy, tubular, sheet, fibrous, and other forms. Particles include not only primary particles but also secondary particles formed by assembling the primary particles.

In the present embodiment, a ratio of a particle diameter of the conductive particles and a particle diameter of the functional particles is controlled so that the particle diameter of the conductive particles is greater than or equal to the particle diameter of the functional particles. In the present embodiment, a particle diameter of the conductive auxiliary agent 104b as the conductive particles is set to be greater than or equal to a particle diameter of the carbon dioxide adsorbent 104a as the functional particles.

In the present disclosure, the particle diameter of the conductive particles and the functional particles is a length of a largest portion of a particle diameter, which may also be referred to as a maximum diameter or long diameter of a particle. In other words, a length of the conductive particles in at least one axial direction becomes greater than or equal to the particle diameter of the functional particles. Fibrous particles, such as the carbon fiber nonwoven fabrics, are not linearly extended but in a non-linear state, and a particle diameter of the fibrous particles is a linear distance from one end to the other end in a non-linear state.

In the present embodiment, a mode (peak value) of particle diameter distribution is used as the particle diameter. The particle diameter may be obtained as follows.

A geometric shape of particles is observed by using an electron microscope (SEM, TEM) or an atomic force microscope (AFM); thereby, the maximum diameter of a particle is measured. The number of measurement samples N should be 30 or more, for example. The mode estimated by assuming that a distribution of the maximum diameter of each measured particle is log-normally distributed is obtained as the particle diameter.

By making the particle diameter of the conductive particles greater than or equal to the particle diameter of the functional particles, the particle diameter of the conductive auxiliary agent 104b as the conductive particles increases, and adjacent conductive auxiliary agents 104b are likely to contact each other. As a result, a contact ratio of the conductive auxiliary agent 104b can be increased. This facilitates the formation of the conductive paths by the conductive auxiliary agent 104b and improves the electrical conductivity per unit volume.

Furthermore, by increasing the particle diameter of the conductive auxiliary agent 104b, the number of the particles of the conductive auxiliary agent 104b configuring the conductive path is decreased, and the number of intergranular boundaries per transmission distance, which an electron passes through, is decreased. This reduces an intergranular resistance of multiple conductive auxiliary agents 104b forming the conductive path. As a result, the electrical conductivity per unit volume can be further improved.

A relationship between the electrical conductivity of an electrode containing the conductive particles and a volume ratio of the conductive particles in the electrode is explained here, referencing FIG. 6. A vertical axis in FIG. 6 is the logarithm of the electrical conductivity of the electrode, and a horizontal axis is the volume ratio of the conductive particles. In FIG. 6, carbon black with a particle diameter of 0.04 m and RuO₂ with a particle diameter of 0.5 m are used as the conductive particles. In FIG. 6, the conductive particles with the particle diameter of 0.5 m are shown as circles and solid lines. The conductive particles with the particle diameter of 0.04 m are shown as squares and dashed lines. An effect of a difference in the electrical conductivity of each of the RuO₂ and carbon black on the electrical conductivity of the electrode is negligible compared to an effect of the particle diameter on the electrical conductivity of the electrode.

As shown in FIG. 6, when compared at the same volume ratio, the conductive particles with the particle diameter of 0.5 m have improved the electrical conductivity compared to the conductive particles with the particle diameter of 0.04 m. In other words, the conductive particles with the particle diameter of 0.5 m can reduce the volume ratio to obtain the same electrical conductivity compared to the conductive particles with the particle diameter of 0.04 m. In an example shown in FIG. 6, the conductive particles with the particle diameter of 0.04 m have the electrical conductivity of 1 S/m at the volume ratio of about 0.6. In contrast, the conductive particles with the particle diameter of 0.5 m have the electrical conductivity of 1 S/m at the volume ratio of about 0.4.

As shown in FIG. 6, regardless of the particle diameter of the conductive particles, as the volume ratio of the conductive particles is increased from zero, there is the volume ratio at which the electrical conductivity increases rapidly. The volume ratio at which the electrical conductivity increases rapidly is a critical volume ratio. When the volume ratio of the conductive particles is increased above the critical volume ratio, an increase rate in the electrical conductivity becomes slower. Even if the volume ratio of the conductive particles becomes higher, the electrical conductivity is difficult to increase. In the example shown in FIG. 6, the conductive particles with the particle diameter of 0.5 m have the critical volume ratio of about 0.3, and the conductive particles with the particle diameter of 0.04 m have the critical volume ratio of about 0.5.

In a region where the volume ratio of the conductive particles is lower than the critical volume ratio, the electrical conductivity is substantially zero. Therefore, the volume ratio of the conductive particles needs to be above the critical volume ratio.

In the present embodiment, in a thickness direction of the working electrode 104, the electrical conductivity of the working electrode 104 makes to be greater than or equal to 1/10 of the electrical conductivity when a volume ratio of the conductive auxiliary agent 104b is 100%. This allows the volume ratio of the conductive auxiliary agent 104b in the working electrode 104 to be maintained above the critical volume ratio. In other words, the adjacent conductive auxiliary agents 104b can be brought into contact with each other in the working electrode 104, ensuring that the conductive path formed by the conductive auxiliary agents 104b remains uninterrupted. The thickness direction of the working electrode 104 is a direction connecting the working electrode current collector 103 and the separator 107 through the working electrode 104.

The electrical conductivity per volume may be calculated as a reciprocal of volume resistivity. The volume resistivity corresponds to a value of an electrical resistance per unit volume and may be calculated using the following equation.

Volume resistivity (Ω·m)=Electrical resistance (Ω)×Area (m²)/Thickness (m)

The working electrode 104 containing the conductive auxiliary agent 104b is created. The conductive particles of the same material and particle diameter distribution as the conductive auxiliary agent 104b are cut or molded into cylindrical, prismatic, or sheet-like shapes to prepare measurement samples. The conductive particles of the same material and particle diameter distribution as the conductive auxiliary agent 104b are the measurement samples of the conductive auxiliary agent 104b with the volume ratio of 100%. The working electrode 104 and the measurement sample of the conductive particles to be compared are each fastened with a metal flat plate with the same load in the thickness direction, and their electrical resistance is measured. The above equation can calculate the volume resistivity using the measured value of the electrical resistance along with an area and thickness of the measurement sample.

In the present embodiment, the volume ratio of the conductive auxiliary agent 104b is set to be greater than or equal to a volume ratio of the binder 104c in the working electrode 104. This allows the volume ratio of the conductive auxiliary agent 104b in the working electrode 104 to be ensured so that the volume ratio of the conductive auxiliary agent 104b in the working electrode 104 is above the critical volume ratio.

The conductive particles and the functional particles may be adjusted to the desired particle diameter. For example, when reducing the particle diameter by adjusting it, the particles may be pulverized using a planetary ball mill, e.g., to achieve a target particle diameter.

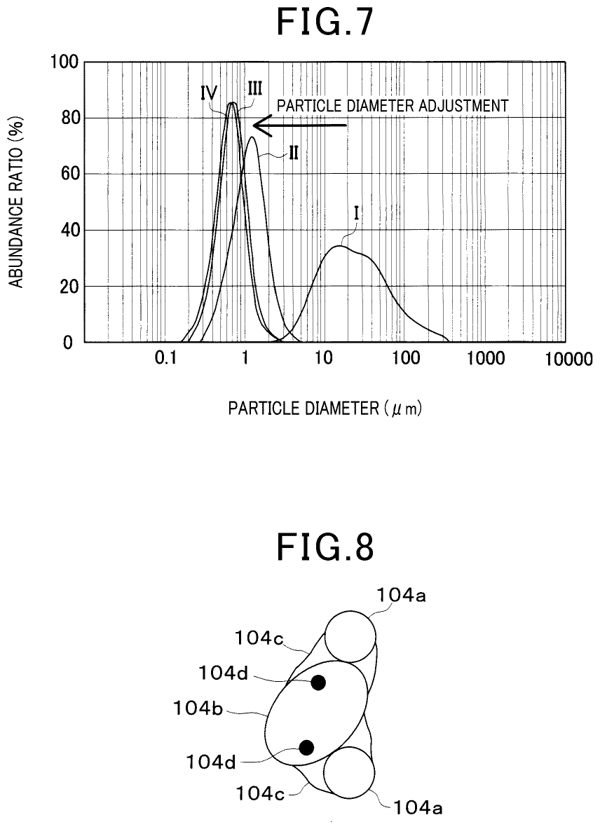

FIG. 7 shows a relationship between the particle diameter and an abundance ratio of the particles when the particle diameter is reduced by adjusting it. In FIG. 7, I, II, III, and IV indicate the order of progression of the particle diameter adjustment. Thus, FIG. 7 shows the particle diameter distribution when progressing the particle diameter adjustment in the order shown in the ordinal numbers. As shown in FIG. 7, the particle diameter of the particles decreases with the progression of the particle diameter adjustment. Furthermore, with the progression of the particle diameter adjustment, a range of the particle diameter distribution becomes narrower, and the particle diameter is averaged.

Increasing the particle diameter of the particles may be achieved by creating the secondary particles formed from the assembly of the primary particles. For example, the secondary particles can be obtained by pressing the primary particles together or by agglomerating the primary particles with the binder 104c.

A manufacturing method of the working electrode 104 will be described below.

For example, the carbon dioxide adsorbent 104a, the conductive auxiliary agent 104b, and the binder 104c are dispersed or dissolved in a solvent to create an electrode paste. The created electrode paste is then applied to the working electrode current collector 103 or the separator 107. This allows for a production of the working electrode 104. The carbon dioxide adsorbent 104a and the conductive auxiliary agent 104b may be used as a particle mixture. After the carbon dioxide adsorbent 104a is supported on the conductive auxiliary agent 104b, it may be mixed with the binder 104c. To support the carbon dioxide adsorbent 104a on the conductive auxiliary agent 104b, the carbon dioxide adsorbent 104a, which is dispersed or dissolved in a solvent, may be coated onto the conductive auxiliary agent 104b.

The working electrode 104 may be produced by supporting the carbon dioxide adsorbent 104a on the conductive auxiliary agent 104b after forming the conductive framework with the conductive auxiliary agent 104b. In this case, the conductive auxiliary agent 104b and the binder 104c are dispersed or dissolved in the solvent to create an electrode paste. The created electrode paste is then applied to the working electrode current collector 103 or the separator 107 and allowed to dry. This creates a porous body containing the conductive auxiliary agent 104b and the binder 104c. The liquid material in which the carbon dioxide adsorbent 104a is dispersed or dissolved in the solvent is then adhered to the created porous body through permeation or spraying. The solvent is then removed and the carbon dioxide adsorbent 104a is fixed to the conductive auxiliary agent 104b. The solvent used to disperse or dissolve the carbon dioxide adsorbent 104a is a solvent that does not dissolve the binder 104c. Accordingly, for example, a film of carbon dioxide adsorbent 104a and/or binder 104c on a surface of the conductive auxiliary agent 104b with a film thickness of 1/N or less of the particle diameter of the conductive auxiliary agent 104b (N is any integer).

As shown in FIG. 3, the counter electrode current collector 105 is a conductive member that contacts the counter electrode 106 and electrically connects the working electrode 104 to the counter electrode 106. One flat surface of the counter electrode current collector 105 is exposed and in contact with the gas mixture. The other flat surface of the counter electrode current collector 105 is in contact with the counter electrode 106.

The counter electrode 106 transfers the electrons to and from the working electrode 104 when a carbon dioxide adsorbent adsorbs or desorbs the carbon dioxide. The counter electrode 106 includes an electroactive auxiliary material, a conductive auxiliary agent, and a binder. The electroactive auxiliary material, the conductive auxiliary agent, and the binder are used in a mixed state (mixture). Specifically, in the present embodiment, particles of the electroactive auxiliary material and particles of the conductive auxiliary agent are held together by the binder.

The same materials as the conductive auxiliary agent 104b and the binder 104c of the working electrode 104 may be used as the conductive auxiliary agent and the binder of the counter electrode 106. The electroactive auxiliary material is a supplementary electroactive species that transfers electrons to and from the carbon dioxide adsorbent 104a of the working electrode 104 and is an active material with a redox property. For example, organic compounds with π-bonds, transition metal compounds in which one element has multiple oxidation numbers, or metal complexes in which a valence of metal ions changes, enabling electron transfer, may be used as the active material.

Such metal complexes may be included, for example, cyclopentadienyl metal complexes such as ferrocene, nickelocene, cobaltocene, or the like, or porphyrin metal complexes. These metal complexes may be polymers or monomers.

The separator 107 is positioned between the working electrode 104 and the counter electrode 106 to separate the working electrode 104 from the counter electrode 106. The separator 107 is an insulating ion-permeable membrane allowing ions to pass through, which prevents physical contact between the working electrode 104 and the counter electrode 106 to suppress electrical shorts. For example, cellulose membranes, polymers, composites of polymers and ceramics, or the like, may be used as the separator 107.

The electrolyte layer 108 is an immersion layer in which the working electrode 104, the separator 107, and the counter electrode 106 are immersed. For example, an ionic liquid may be used as the electrolyte layer 108. The ionic liquid corresponds to a nonvolatile liquid salt under a normal temperature and normal pressure.

In addition, a power supply 109 is connected to the working electrode current collector 103 and the counter electrode current collector 105 of the electrochemical cell 101. The power supply 109 applies a predetermined voltage to the working electrode 104 and the counter electrode 106 to change a potential difference between the working electrode 104 and the counter electrode 106. The working electrode 104 is a negative electrode, and the counter electrode 106 is a positive electrode.

The electrochemical cell 101 operates in a carbon dioxide capture mode and a carbon dioxide release mode by changing the potential difference between the working electrode 104 and the counter electrode 106. The carbon dioxide carputer mode is a mode in which the carbon dioxide is captured at the working electrode 104. The carbon dioxide release mode is a mode in which the captured carbon dioxide is released from the working electrode 104. The carbon dioxide capture mode also serves as a charging mode that recharges the electrochemical cell 101. The carbon dioxide release mode also serves as a discharge mode that discharges the electrochemical cell 101.

Specifically, in the carbon dioxide capture mode, a first voltage V1 is applied between the working electrode 104 and the counter electrode 106, and electrons are transferred from the counter electrode 106 to the working electrode 104. At the first voltage V1, a working electrode potential is lower than a counter electrode potential (working electrode potential<counter electrode potential). A value of the first voltage V1 is set to be, for example, in a range of 0.5 V or more and 2.0 V or less.

In the carbon dioxide release mode, a second voltage V2 is applied between the working electrode 104 and the counter electrode 106, and electrons are transferred from the working electrode 104 to the counter electrode 106. The second voltage V2 is different from the first voltage V1. The second voltage V2 is set to be lower than the first voltage V1 and is not limited by a magnitude relationship between the working electrode potential and the counter electrode potential. In other words, in the carbon dioxide release mode, the working electrode potential may be lower than the counter electrode potential, the working electrode potential may be equal to the counter electrode potential, or the working electrode potential may be higher than the counter electrode potential.

An operation of the carbon dioxide capture system 1 in the present embodiment will be described below. As described above, the carbon dioxide capture system 1 operates by alternating between the carbon dioxide capture and release modes. The operation of the carbon dioxide capture system 1 is controlled by the control device 14.

First, the carbon dioxide capture mode will be explained. In the carbon dioxide capture mode, the pump 11 is activated. This supplies the gas mixture to the carbon dioxide capture device 10. In the carbon dioxide capture device 10, a voltage applied between the working electrode 104 and the counter electrode 106 of the electrochemical cell 101 is set to the first voltage V1. This allows simultaneous electron donation from the electroactive auxiliary material of the counter electrode 106 and electron acceptance by the carbon dioxide adsorbent 104a of the working electrode 104.

The carbon dioxide adsorbent 104a of the working electrode 104, which has received electrons from the counter electrode 106, exhibits a greater binding capacity for the carbon dioxide. Therefore, the carbon dioxide adsorbent 104a binds and adsorbs the carbon dioxide contained in the gas mixture. This allows the carbon dioxide capture device 10 to capture the carbon dioxide from the gas mixture. The gas mixture removed the carbon dioxide flows from the carbon dioxide capture device 10.

In the carbon dioxide capture mode, the flow-path switching valve 12 switches the gas flow path so that the gas mixture flows from the carbon dioxide capture device 10 to the atmosphere. As a result, the gas mixture flowing out of the carbon dioxide capture device 10 is released into the atmosphere through the switched flow path.

Next, the carbon dioxide release mode will be explained. In the carbon dioxide release mode, the pump 11 is stopped. This stops the supply of the gas mixture to the carbon dioxide capture device 10. In the carbon dioxide capture device 10, a voltage applied between the working electrode 104 and the counter electrode 106 of the electrochemical cell 101 is set to the second voltage V2. This allows simultaneous electron donation from the carbon dioxide adsorbent 104a of the working electrode 104 and electron acceptance by the electroactive auxiliary material of the counter electrode 106.

The carbon dioxide adsorbent 104a of the working electrode 104 releases electrons and enters an oxidized state. The carbon dioxide adsorbent 104a decreases the binding capacity for the carbon dioxide. Thus, the adsorbed carbon dioxide is desorbed and released from the carbon dioxide adsorbent 104a. The carbon dioxide released from the carbon dioxide adsorbent 104a flows to the carbon dioxide capture device 10.

In the carbon dioxide release mode, the flow-path switching valve 12 switches the gas flow path so that the carbon dioxide flows from the carbon dioxide capture device 10 to the inlet of the carbon dioxide utilization device 13. As a result, the carbon dioxide flowing out of the carbon dioxide capture device 10 is supplied to the carbon dioxide utilization device 13 through the switched flow path.

According to the present embodiment described above, in the working electrode 104, the particle diameter of the conductive auxiliary agent 104b as the conductive particles is set to be greater than or equal to the particle diameter of the carbon dioxide adsorbent 104a as the functional particles. This increases the contact ratio between the conductive auxiliary agent 104b in the working electrode 104, thereby improving the electrical conductivity per unit volume. Furthermore, the larger particle diameter of the conductive auxiliary agent 104b decreases the number of the particles of the conductive auxiliary agent 104b configuring the conductive path, thereby decreasing the number of the intergranular boundaries per the transmission distance. This reduces the intergranular resistance of the multiple conductive auxiliary agents 104b forming the conductive path. As a result, the electrical conductivity per unit volume can be further improved.

By making the particle diameter of the conductive auxiliary agent 104b greater than or equal to the particle diameter of the carbon dioxide adsorbent 104a, the electrical conductivity provided by the conductive particles can be ensured even when the volume ratio of the conductive auxiliary agent 104b is reduced. Furthermore, the volume ratio of the carbon dioxide adsorbent 104a as the functional particles can be increased. This improves the functionality provided by the carbon dioxide adsorbent 104a as the functional particles, thereby improving efficiency in adsorbing the carbon dioxide by the working electrode 104.

In the working electrode 104 of the present application, the volume ratio of the conductive auxiliary agent 104b is set to be greater than or equal to the volume ratio of the binder 104c. This ensures the volume ratio of the conductive auxiliary agent 104b in the working electrode 104 and the electrical conductivity provided by the conductive auxiliary agent 104b.

### Second Embodiment

Next, a second embodiment of the present disclosure will be described. Elements that differ from the first embodiment above will be described below.

In the present embodiment, a carbon material is used as the carbon dioxide adsorbent 104a and the conductive auxiliary agent 104b in the working electrode 104. The carbon material used for the carbon dioxide adsorbent 104a and the carbon material used for the conductive auxiliary agent 104b may be the same or different. In the present embodiment, the carbon dioxide adsorbent 104a and the conductive auxiliary agent 104b are included in the conductive particles, and a catalyst is included in the functional particles. The catalyst promotes a chemical reaction that progresses with at least one of the adsorption of the carbon dioxide by the working electrode 104 and the desorption of the carbon dioxide from the working electrode 104. The catalyst will be described below.

When the carbon material is used as the carbon dioxide adsorbent 104a, in the carbon dioxide capture mode, an oxygen reduction reaction indicated in the following reaction equation (1) and a carbonate ion generation reaction indicated in the following reaction equation (2) progress in the working electrode 104. As a result, the carbon dioxide is adsorbed to the working electrode 104. In other words, the oxygen reduction reaction triggers the adsorption of carbon dioxide to the working electrode 104.

O₂+2ₑ⁻→O₂⁻ (1)

O₂⁻+CO₂→½O₂+CO₃²⁻ (2)

In the working electrode 104, the oxygen reduction reaction progresses. In the oxygen reduction reaction, oxygen in the gas mixture is reduced by receiving electrons to produce superoxide O₂⁻ which is a type of active oxygen. The active oxygen O₂⁻ produced in the oxygen reduction reaction is highly reactive, and the carbonate ion formation reaction progresses. In the carbonate ion formation reaction, the carbon dioxide is oxidized the carbon dioxide to produce a carbonate ion CO₃²⁻ which is an oxide ion of the carbon dioxide. As a result, the carbon dioxide is adsorbed to the working electrode 104. In other words, the active oxygen O₂⁻ generated by the oxygen reduction reaction contributes to adsorbing the carbon dioxide by the working electrode 104.

In the carbon dioxide release mode, at least one of carbonate ion dissociation reactions indicated in the following reaction equations (3) and (4) progresses in the working pole 104. In the carbonate ion dissociation reaction, the carbonate ion CO₃²⁻ is dissociated. As a result, the carbon dioxide is produced. In other words, the carbonate ion dissociation reaction triggers the desorption of carbon dioxide from the working pole 104.

CO₃²⁻+C→3CO₂+4e⁻ (3)

2CO₃²⁻→O₂+2CO₂+4e⁻ (4)

As shown in FIG. 8, the catalyst 104d is added to the working electrode 104 in the present embodiment. The catalyst 104d promotes at least one of the oxygen reduction reaction and the carbonate ion dissociation reaction. Such catalyst 104d may be used, for example, metal particles containing at least one of Al, Cu, Ni, Ag, Au, and Pt, or metal oxide particles containing at least one of RuO₂, MnO₂, and MoO₂. The catalyst 104d may be supported on the conductive auxiliary agent 104b, for example.

As described above, in the present embodiment, the catalyst 104d is included in the functional particles. In the present embodiment, even if materials used as the catalyst 104d itself have more electrical conductivity than the conductive particles, the catalyst 104d does not form the conductive path because main purpose of the catalyst 104d is not to exhibit the electrical conductivity. Therefore, catalyst 104d is included in the functional particles.

In the present embodiment, each of the particle diameters of the carbon dioxide adsorbent 104a and the conductive auxiliary agent 104b as the conductive particles is set to be greater than or equal to the particle diameter of the catalyst 104d as the functional particles. Therefore, as in the first embodiment above, the contact ratio between the conductive particles in the working electrode 104 can be increased, thereby improving the electrical conductivity per unit volume.

By making the particle diameter of the conductive auxiliary agent 104b greater than or equal to the particle diameter of the carbon dioxide adsorbent 104a, the electrical conductivity provided by the conductive particles can be ensured even when the volume ratio of the conductive auxiliary agent 104b is reduced. Furthermore, the volume ratio of the catalyst 104d as the functional particles can be increased. This improves the functionality provided by the catalyst 104d as the functional particles, thereby improving efficiency in adsorbing the carbon dioxide by the working electrode 104.

### Third Embodiment

Next, a third embodiment of the present disclosure will be described. Elements that differ from each of the above embodiments will be described below.

In the present embodiment, a conductive polymer is used as the binder 104c in the working electrode 104. The conductive polymer is a polymer with π-bonds, including examples such as polyacetylene, polypyrrole, poly(p-phenylene), poly(3-methylthiophene), and poly(3-hexylthiophene).

In the present embodiment, by using the conductive polymer as the binder 104c, the binder 104c itself may have the electrical conductivity. The binder 104c is provided to cover at least the conductive auxiliary agent 104b. The use of the binder 104c containing the conductive polymer allows the conductive auxiliary agent 104b to maintain the electrical conductivity through the binder 104c, even if the entire conductive auxiliary agent 104b is covered with the binder 104c.

The binder 104c covering the conductive auxiliary agent 104b can complement the conductive path formed by the conductive auxiliary agent 104b. In other words, even if there is a gap between the adjacent conductive auxiliary agents 104b and they are connected through the binder 104c, the conductive auxiliary agent 104b and the binder 104c may form the conductive path. The conductive framework is configured by the binder 104c containing the conductive polymer and the conductive auxiliary agent 104b.

The binder 104c may contain a non-conductive polymer in addition to the conductive polymer. The binder 104c containing the non-conductive polymer has superior a binding property to the binder 104c containing the conductive polymer. The binder 104c containing both conductive and non-conductive polymers is preferably made of the conductive polymer for a portion in contact with the conductive auxiliary agent 104b and non-conductive polymers for a portion not in contact with the conductive auxiliary agent 104b. This allows the binder 104c to maintain electrical conductivity in the portion where it contacts the conductive auxiliary agent 104b and improves the binding property in other portions.

The present disclosure is not limited to the above embodiments and can be modified differently without deviating from its intended purpose. The components disclosed in each of the above embodiments may be combined as suitable and feasible.

For example, each of the above embodiments describes the configurations for adsorbing the carbon dioxide contained in the gas mixture by the electrochemical cell 101, but it is not limited to these configurations. For example, the electrochemical cell 101 may be used to adsorb other gases, such as oxygen, from the gas mixture.

In each of the above embodiments, in the working electrode 104, the particle diameter of the conductive particles is configured to be greater than or equal to the particle diameter of the functional particles, but it is not limited to this configuration. For example, the counter electrode 106 may be configured so that the particle diameter of the conductive particles is greater than or equal to the particle diameter of the functional particles. In this case, the conductive particles include the conductive auxiliary agent for the counter electrode 106, and the functional particles include the conductive auxiliary agent for the counter electrode 106.

Features of the electrochemical cell of the present disclosure are as follows.

### Aspect 1

An electrochemical cell having a working electrode (104) and a counter electrode (106), adsorbing a gas to the working electrode, and desorbing the adsorbed gas from the working electrode, by applying a voltage between the working electrode and the counter electrode, in which:
at least one electrode of the working electrode and the counter electrode has conductive particles (104b) that contact each other to form conductive paths and functional particles (104a) that do not form the conductive paths; and
a particle diameter of the conductive particles is configured to be greater than or equal to a particle diameter of the functional particles.

### Aspect 2

The electrochemical cell is according to aspect 1, in which, the functional particles are a gas adsorbent that adsorbs the gas and desorbs the adsorbed gas.

### Aspect 3

The electrochemical cell is according to aspect 1 or 2, in which, the functional particles are a catalyst (104d) that promotes a chemical reaction that progresses with at least one of the adsorption of the gas by the working electrode and the desorption of the gas from the working electrode.

### Aspect 4

The electrochemical cell is according to any one of aspects 1 to 3, in which, the electrode has a binder (104c), and in the electrode, a volume ratio of the conductive particles is configured to be greater than or equal to a volume ratio of the binder.

### Aspect 5

The electrochemical cell is according to aspect 4, in which, the binder contains a conductive polymer and forms the conductive paths together with the conductive particles.

While the present disclosure has been described with certain embodiments, it is not limited to those specific structures. This disclosure also encompasses modifications and variations that fall within the scope of its equivalences. Additionally, this disclosure presents various combinations and embodiments; other combinations and embodiments, which may include one, more, or fewer elements, are also considered within its scope.

What is claimed is:

1. An electrochemical cell adsorbing a gas to a working electrode, and desorbing the adsorbed gas from the working electrode, by applying a voltage between the working electrode and a counter electrode, comprising the working electrode and the counter electrode, wherein:
at least one electrode of the working electrode and the counter electrode has conductive particles that contact each other to form conductive paths and functional particles that do not form the conductive paths; and
a particle diameter of the conductive particles is configured to be greater than or equal to a particle diameter of the functional particles.

2. The electrochemical cell according to claim 1, wherein,
the functional particles are a gas adsorbent that adsorbs the gas and desorbs the adsorbed gas.

3. The electrochemical cell according to claim 1, wherein,
the functional particles are a catalyst that promotes a chemical reaction that progresses with at least one of the adsorption of the gas by the working electrode and the desorption of the gas from the working electrode.

4. The electrochemical cell according to claim 1, wherein:
the electrode has a binder; and
in the electrode, a volume ratio of the conductive particles is configured to be greater than or equal to a volume ratio of the binder.

5. The electrochemical cell according to claim 4, wherein,
the binder contains a conductive polymer and forms the conductive paths together with the conductive particles.
